(19) United States
(12) Patent Application Publication
(10) Pub. No.: US 2012/0284083 A1
(43) Pub. Date: Nov. 8, 2012

(54) System and method for merchandise distribution

(75) Inventors: Bo Wu, Beijing (CN); GuoHua Lu, Beijing (CN); Yuhong Xiong, Beijing (CN)

(73) Assignee: LaShou Group INC.

(21) Appl. No.: 13/068,217

(22) Filed: May 4, 2011

(51) Int. Cl. G06Q 30/00; G06Q 10/00

(52) U.S. Cl. 705/7.31

(57) ABSTRACT

A lightweight merchandise distribution system for online group-buying is provided. The distribution system comprises a computer server, a plurality of small distribution centers, and a plurality of delivery entities. The computer server comprises a merchandise sales-prediction module and a distribution center-optimization module. Before a product is featured on a group-buying website, the number of small distribution centers is set up in a densely populated city based on the center-optimization result. The featured product is then pre-allocated to each distribution center based on the sales-prediction result. Each delivery entity comprises a delivery person, a wireless handheld device, and a delivery vehicle. The delivery person preloads the featured products onto the delivery vehicle before receiving any order. The delivery person delivers the ordered product by the delivery vehicle once the purchase order is received from the wireless handheld device.

### TECHNICAL FIELD

The present invention relates generally to e-commerce and, more particularly, to system and method for merchandise distribution.

### BACKGROUND

In traditional logistics adopted by online retailers, a number of large warehouses are built for stocking merchandise. Each warehouse covers a large region, i.e., several states or provinces in a country or even several countries. Online retailers procure merchandise from manufacturers and wholesalers, and stock them in the warehouses. The number of different types of merchandise provided by online retailers is usually very large, from thousands to tens of millions. A complex warehouse management system (WMS) and a warehouse control system (WCS) are thus required to manage inventory and product flow in each warehouse.

FIG. 1 (Prior Art) illustrates a typical merchandise distribution procedure adopted by an online retailer. Before the online retailer starts the merchandise distribution process, the online retailer first receives orders from its customers. For example, a server computer 11 may be used by the online retailer for receiving and processing an order initiated from a laptop 12 of a consumer 18 via the Internet. The order may include consumer information, product information, and shipping and delivery information. After the order has been received and processed, the typical merchandise distribution procedure generally includes three stages: packaging, shipping, and delivering. During the first stage of packaging, the online retailer finds the ordered product in a large warehouse 13, packages the product into a package 14, prints and pastes a shipping label to package 14, and then starts the shipping process. During the second stage of shipping, the online retailer either uses its own shipping division or a third-party shipping company to ship the products. The shipping process usually involves the computation of the route for transportation, and the actual movement of the package along the route. For example, package 14 may be carried and shipped via an airplane 15 as part of the transportation route. In the last hop of the transportation route, a delivery person 17 loads a number of packages addressed within a small area onto a large delivery truck 16 and delivers them one by one. During the final stage of delivering, package 14 is finally delivered to customer 18 by delivery person 17. A tracking system is often implemented for monitoring the current location of the package throughout the complex distribution process.

For consumers, the time between placing the order and the time receiving the products is usually between a day to a few weeks, depending on the distance between the warehouse location and the delivery destination. A lightweight merchandise distribution system is desired over the traditional system.

### SUMMARY

A lightweight merchandise distribution system for online group-buying is provided. The distribution system comprises a computer server, a plurality of small distribution centers, and a plurality of delivery entities. The computer server comprises a merchandise sales-prediction module, a distribution center-optimization module, and an order processing module. Before a product is featured on a group-buying website, a number of small distribution centers are set up in a densely populated city based on center-optimization result determined by the distribution center-optimization module. The featured product is then pre-allocated to each distribution center based on sales-prediction result determined by the merchandise sales-prediction module. Finally, the order processing module receives an order from a consumer and dispatches order information to one of the plurality of delivery entities that is very close to a consumer delivery address for fast and efficient delivery.

In one, embodiment, the featured product is advertised on a group-buying website to be sold at a discount price within a short duration of time. In one example, the center-optimization result is based on a list of factors comprising sales address distribution, population/building coverage, traffic condition, availability of office space, and office rental in the densely populated city. In another example, the sales-prediction result is based on a list of factors comprising sales volume distribution, product category, time/season factor, and demographic information associated with the distribution center.

In one novel aspect, the ordered product is moved to a location very close to the final delivery address before the order is even placed. In one embodiment, each delivery entity comprises a delivery person, a wireless handheld device, and a delivery vehicle. The delivery person preloads the featured products onto the delivery vehicle before receiving any order. The delivery person delivers the ordered product by the delivery vehicle once the order information is received from the wireless handheld device. In another novel aspect, the lightweight merchandise distribution system does not require a complicated tracking system, nor does it require additional packaging. In yet another novel aspect, each distribution center can be very small, and each delivery vehicle can also be a small truck or van because only a few different types of products are featured in each group-buying sales campaign during a short duration of time.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 (Prior Art) illustrates a typical procedure adopted by online retailers.

FIG. 2 illustrates a lightweight merchandise distribution system in accordance with one novel aspect.

FIG. 3 is a detailed online group-buying procedure using a novel lightweight merchandise distribution system.

FIG. 4 illustrates a web-based online retail system 40 that facilitates lightweight merchandise distribution for group-buying.

FIG. 5 illustrates a plurality of distribution centers in a novel lightweight merchandise distribution system to optimize delivery time and cost.

FIG. 6 is a simplified map that illustrates one example of selecting distribution center locations using clustering algorithms.

FIG. 7 illustrates one embodiment of distribution center-location selection using clustering algorithms.

FIG. 8 illustrates a plurality of delivery entities associated with a small distribution center in a lightweight distribution system.

FIG. 9 illustrates a novel delivery method in a lightweight distribution system.

FIG. 10 is a flow chart of a method of receiving and dispatching group-buying orders in accordance with one novel aspect.

FIG. 11 is a flow chart of a method of delivering group-buying products in accordance with one novel aspect.

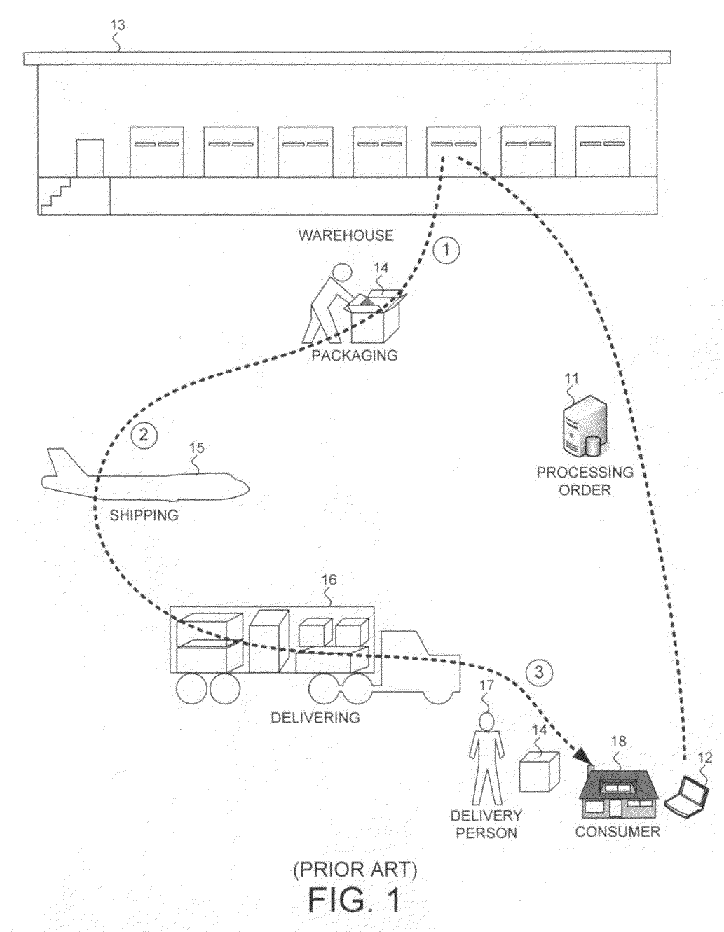

### DETAILED DESCRIPTION

Reference will now be made in detail to some embodiments of the invention, examples of which are illustrated in the accompanying drawings.

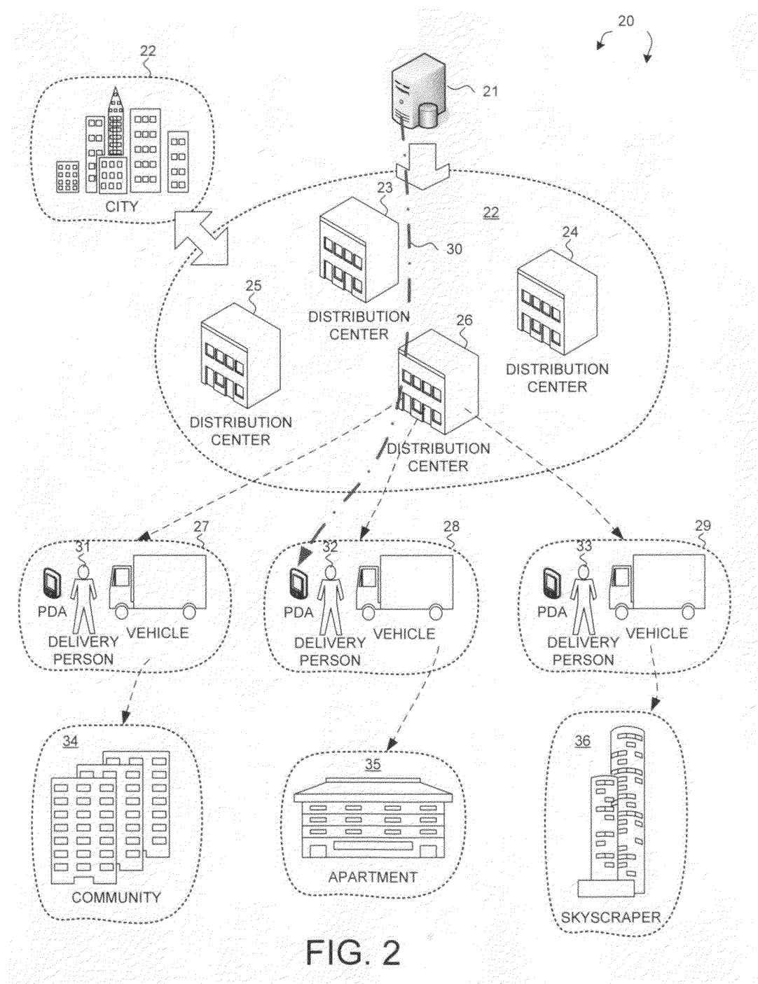

FIG. 2 illustrates a lightweight merchandise distribution system 20 in accordance with one novel aspect. Merchandise distribution system 20 comprises a server computer 21, a plurality of distribution centers (e.g., 23-26), and a plurality of delivery entities (e.g., 27-29). Distribution system 20 is owned by a group-buying company that provides discounted products to large groups of consumers for sales campaigns made in a short duration of time via online group-buying websites. In one novel aspect, the group-buying company utilizes server computer 21 (e.g., located in a central office of the group-buying company) and various optimization algorithms to set up a large number of small distribution centers (e.g., located in different cities where an online group-buying service is provided), to promote products at deep discount price with large sales volume, to pre-allocate products to each distribution center based on sales-prediction so as to minimize delivery time and cost, and to employ delivery entities for efficient delivery to the consumers.

As illustrated in FIG. 2, the group-buying company sets up four distribution centers 23-26 in city 22. Before a product is featured on a group-buying website, the group-buying company first receives the product from its supplier, and then pre-allocates the product to each distribution center that covers a region in which the product will be sold in city 22. In addition, each distribution center (e.g., center 26) is equipped by a certain number of delivery entities (e.g., 27-29), and each delivery entity includes a delivery person that drives a small delivery vehicle loaded with the product while carrying a wireless handheld device. In the example of FIG. 2, distribution center 26 is staffed with three delivery persons 31-33, and each delivery person covers a certain area within the region covered by distribution center 26. For example, delivery person 31 covers area 34, delivery person 32 covers area 35, and delivery person 33 covers area 36 respectively.

At the beginning of every work day, each delivery person loads the product being sold in the vehicle and goes to the area he/she covers and waits for orders. As orders come in, the group-buying company processes and dispatches the order to the delivery person closest to the delivery address. In one example, as depicted by a thick dash-dotted line 30, delivery person 32 receives the order from the wireless handheld device (e.g., a PDA) and delivers the product to area 35 accordingly. In a traditional merchandise distribution system, products are stocked in large warehouses that are far away from the consumer. The products do not start to move toward the consumer until the order is received and processed. In the novel merchandise distribution system 20, however, the products are moved to a location very close to the consumer even before the consumer places the order. In densely populated commercial zones or residence areas, the products may be waiting just outside the office building or in the same neighborhood when the consumer places the order on the group-buying website. As a result, under the novel distribution system, it is possible to have consumers to receive products within ten minutes after the order is placed.

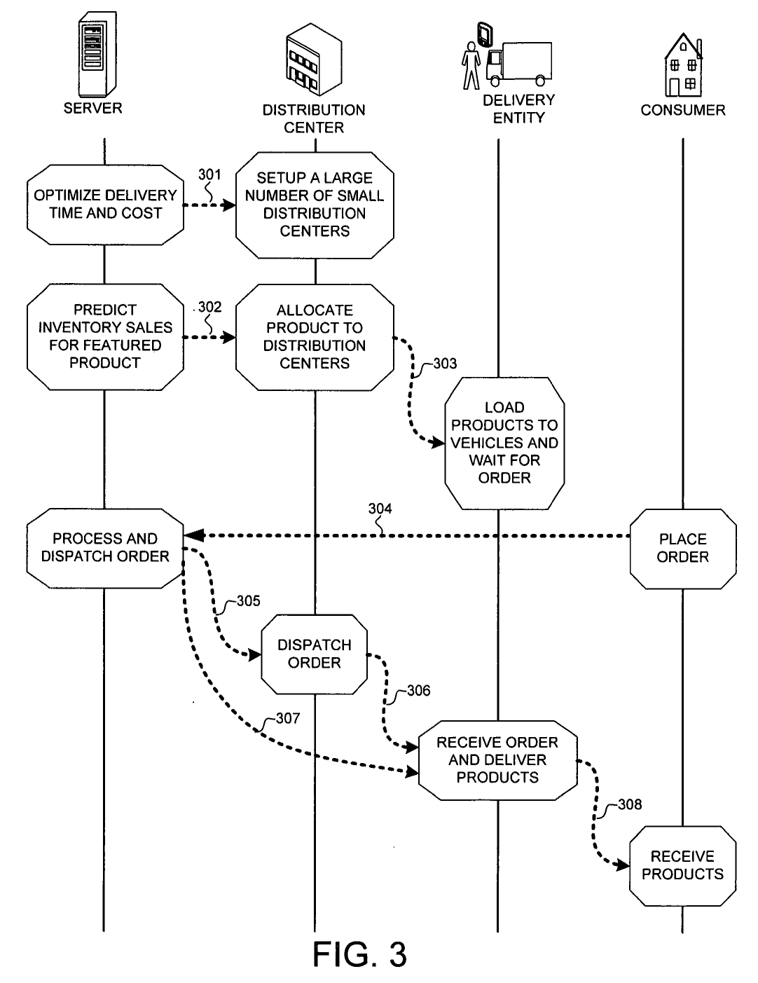

FIG. 3 is a detailed online group-buying procedure using the above-illustrated novel lightweight merchandise distribution system 20. In the example of FIG. 3, a group-buying company deploys the novel lightweight merchandise distribution system 20 to provide online group-buying services to large groups of densely populated consumers. First, before launching any group-buying sales campaign, the group-buying company first sets up a large number of small distribution centers in many cities or towns (step 301). The number of centers, the location, and the size of each center, are chosen by a server computer to optimize the overall delivery time and cost. Next, before a group-buying website features a particular product, the group-buying company pre-allocates the product to distribution centers that cover the regions in which the product will be sold (step 302). The allocation is made by the server computer based on predicted sales for the featured product in a region covered by a corresponding distribution center. Over-allocation is often used if there is enough supply. Next, within each distribution center, the featured product is loaded onto a delivery vehicle by a delivery person in charge of a particular area within the region covered by each center (step 303). Typically, each delivery person preloads the product at the beginning of every work day, and then drives the vehicle to areas likely to get orders. This way, orders received during the day will be delivered immediately. On the other hand, orders received overnight will be delivered at the beginning of the next day.

After one or more products are featured on the group-buying website, consumers start to purchase the products by placing orders (step 304). Because of the nature of group-buying, a large number of orders are expected be placed very quickly due to the deep discount price of the featured products and the very limited time window for the sales campaign (e.g., one day or one week). When the server computer receives an order, it quickly processes the order and dispatches order information (e.g., consumer info, product info, and delivery info) to a corresponding distribution center that is the closest to the final delivery address of the order (step 305). The distribution center then further dispatches the order information to a delivery person who is the closest to the final delivery address (step 306). Alternatively, the server computer may dispatch the order information to the delivery person directly (step 307). Finally, the delivery person receives the order information from its wireless handheld device and delivers the product to the consumer accordingly (step 308). The operations and advantages of the novel merchandise distribution system are now described below with more details.

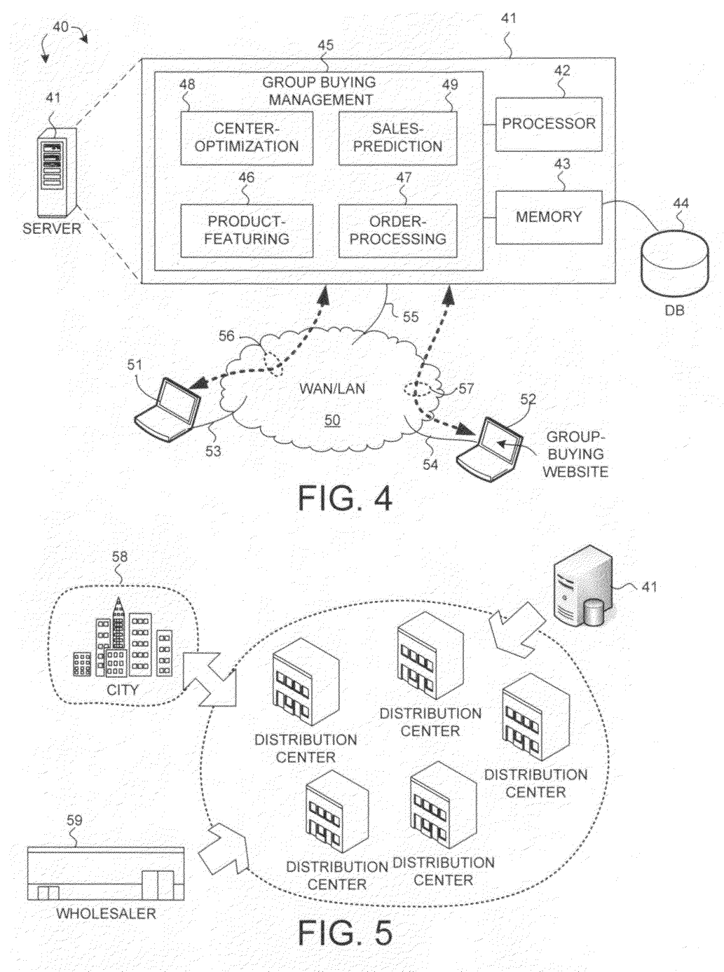

FIG. 4 illustrates a web-based online retail system 40 that facilitates lightweight merchandise distribution for group-buying. Online retail system 40 comprises a server computer 41, a first client computer 51, a second client computer 52, and a wide-area network (WAN) or local-area network (LAN) 50 that interconnects the server and client computers together via wired or wireless communication links 53-55. Online retail system 40 is used by an online group-buying company as a tool to provide group-buying services to consumers. Basically, consumers use client devices to purchase featured products at a discount price during a group-buying sales campaign that is made in a short duration of time. For example, through a group-buying website, the group-buying company features one or more products every day. The featured product is sold at a discount price during the day, with such deal expiring at the end of the day. In addition, the deal may not be valid until a minimum number of products have been ordered. By lowering the sales price while raising the sales quantity, the group-buying company encourages more consumers to purchase the featured product and thereby increases its sales profit.

In the example of FIG. 4, server computer 41 comprises a processor 42, memory 43 that connects to a permanent database DB44, and a group-buying management module 45. Group-buying management module 45 comprises a product-featuring module 46, an order-processing module 47, a distribution center-optimization module 48, and a merchandise sales-prediction module 49. Product-featuring module 46 features a product for sale via a group-buying website. Order-processing module 47 receives, processes, and dispatches purchase orders from the consumers. Distribution center-optimization module 48 determines center-optimization result by optimizing the number, size, and location of the distribution centers to minimize delivery time and cost. Finally, merchandise sales-prediction module 49 determines sales-prediction result by predicting sales volume of the featured product from each distribution center, such that an estimated amount of the featured product is pre-allocated to a corresponding distribution center before the sale occurs to achieve fast and efficient delivery.

The different modules within group-buying management module 45 are function modules that interwork with each other. The function modules, when executed by processor 42, allow online retail system 40 to effectively and efficiently manage online orders by exchange communication messages (e.g., 56 and 57) in online retail system 40. For example, a customer uses a display screen of client computer 52 to browse product information via a group-buying website provided by product-featuring module 46, and then places order via order-processing module 47. The activities performed by the customer and the information related to the purchase orders are saved by server 41 onto DB44. The information is used not only for shipping and delivering purpose, but also for collecting data statistics to be used by center-optimization module 48 and sales-prediction module 49 in the future.

FIG. 5 illustrates a plurality of distribution centers in a novel lightweight merchandise distribution system to optimize delivery time and cost. Traditionally, online retailers set up a number of large warehouses, and each covers several states or provinces in a country or even several countries. A traditional warehouse is very big, some as large as ten football fields. The construction cost for such warehouse thus can be very high. However, because majority rural and suburban areas have very low population density, it is more cost effective to set up few large warehouses, each covering a large region. In urban areas, however, most cities and towns have much higher population density. The volume of online ordered products in an urban area thus may be very big, especially for online orders received during a group-buying sales campaign. As a result, it may be more cost effective to set up many small distribution centers in each city to facilitate fast delivery. In fact, each distribution center can be as small as an apartment (e.g., a few hundreds of square meters). For example, a large city may have 3-40 small distribution centers, with each center covering a densely populated commercial or residential region within the city.

The number, location, and size of the distribution centers of a city may be determined by distribution center-optimization module 48 of server 41. Multiple factors will affect the optimization result. The factors include, but are not limited to: the distribution of potential sales in the city based on the distribution of past sales and the distribution of office buildings and residence complexes in the city; the traffic condition in different parts of the city; and the availability and cost of office space for the centers in different parts of the city. Based on those factors, the location of the centers may be determined by minimizing the distance between a center and the potential sales region it covers, by minimizing delivery time based on traffic route and condition, or by minimizing operation costs including rents for the centers. In general, the more centers, the shorter the distance between a center and the potential sales, but with a higher cost. The final decision is a trade-off among all the factors. A number of methods can be used to solve the optimization problem, including the use of heuristics, multivariable optimization algorithms, and clustering algorithms.

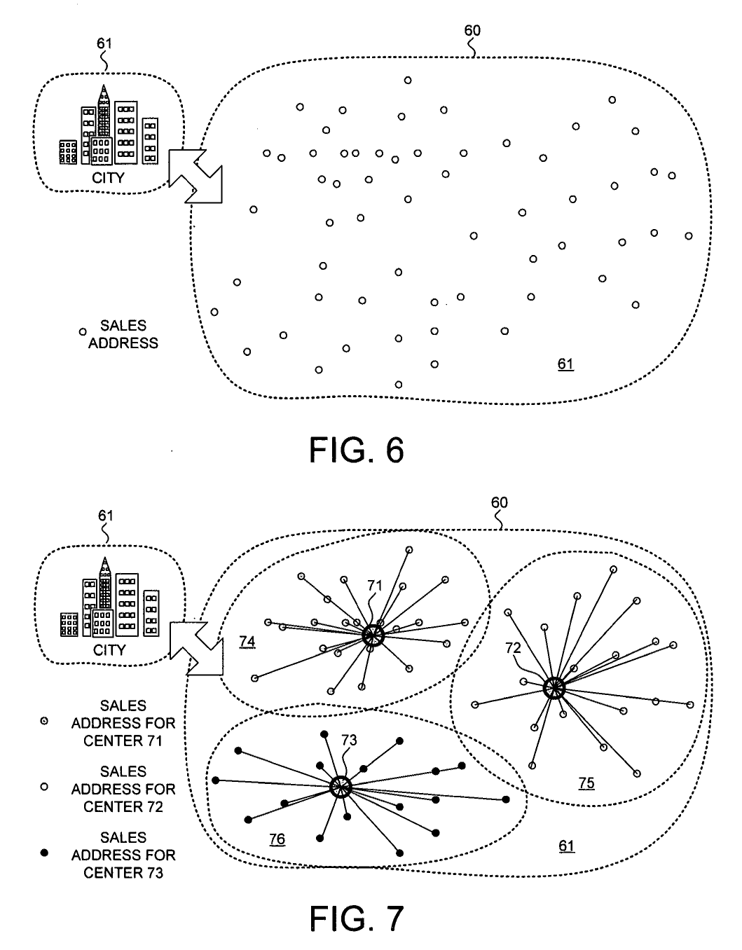

FIG. 6 is a simplified map 60 that illustrates one example of selecting distribution center locations using clustering algorithms. In the example of FIG. 6, the small dots in map 60 represent the distribution of delivery addresses of past sales in a certain time period (e.g., the previous month, or several months, or a year) for a specific city 61. If there are K distribution centers, then the location of the K distribution centers may be optimized via minimizing the total distance between the K centers to each of the past sales addresses. Since multiple sales may be delivered in a single trip, the algorithm also needs to take this into account. For example, the addresses in the same building or in nearby buildings may be merged before optimizing the total distance. When calculating the total distance, each address is assigned to the corresponding nearest center, or assigned to a center where other factors such as traffic are considered. The traffic factor could be included either in the calculation of the total distance or in the assessment of maintenance costs.

FIG. 7 illustrates one embodiment of center-location selection for city 61 using clustering algorithms. In the example of FIG. 7, three distribution centers (K=3) are set up in city 61. Center 71 covers region 74, center 72 covers region 75, and center 73 covers region 76. The location of centers 71-73 are optimized such that the total distance between the three centers and the past sales addresses is minimized. Similar optimization may be solved for varying the value of K. For example, the total distance for each of the sales addresses may be optimized for K=3, K=4, or K=5. Furthermore, multiple sets of optimizations may be performed to select the best solution with the lowest cost. For example, a total of thirty (30) solutions with ten (10) sets of center locations for K=3, 4, and 5 may be calculated, and the best solution with the lowest cost may be selected among the thirty solutions. In addition to the number and location of the distribution centers, the size of each center (e.g., the space required for short-term product storage, the staff size, etc.) could also be computed by the sales addresses it covered. Take K=4 with 1,000 sales address as an example. If the sales volume for a product were 200, 270, 220, and 310, respectively for each of the four centers in the previous month or year, then the size of each distribution center can be set according to the maximum sales volume, plus some room for future growth.

Now referring back to FIG. 5, once a number of distribution centers have been set up by the group-buying company, each center will be pre-allocated with a certain volume of the featured products before the sale actually starts. As illustrated in FIG. 5, five distribution centers (K=5) are set up for city 58. The group-buying company receives the featured product from its supplier (e.g., wholesaler 59), and pre-allocates the estimated product volume to each distribution center accordingly. The pre-allocation may be determined by sales-prediction module 49 of server 41 based on estimated sales from each center for each product sold in city 58. The factors used to estimate the sales from each center for each product include, but are not limited to: past sales volume of the same product in the region covered by each center; past sales volume of related products in the region covered by each center; product category; time and season factor; demographic information for each region; and the sales volume of other related websites. A number of methods such as regression, time series analysis, or heuristics can be used to estimate the sales from each center.

In one embodiment, the estimation of the sales from each center for a specific product is performed in two steps. In the first step, the total sales volume in the city is estimated. For example, traditional techniques for sales forecasting—such as regression based on the information of past sales of related goods, the sales on the related websites of the same product, and the trend and seasonal factors—may be used to estimate the total sales volume. In the second step, sales distribution (proportion) over the different centers is estimated. For example, if the same product has been sold before, the recorded proportion may be used directly. On the other hand, if a new product is being sold for the first time, then the proportion of the sales of related products may be used. Take an example of four centers (K=4). If a sales distribution array α=[0.2, 0,3, 0.15, 0.35] represents the proportion of the sales of related product from the four centers, then such distribution may be used directly for the new product. Alternatively, a sales distribution array β=[0.2, 0.27, 0.22, 0.31] may be used to smooth α. The sales distribution array β represents the proportion of the sales of all products from the four centers. The smoothing calculation could be a simple linear interpolation (α+c*β)/normalize where c is a coefficient. If c=1, then the sales distribution result becomes γ=[0.20, 0.29, 0.19, 0.33]. For example, if the estimated total sales volume of the product in the city is 1,000 units, then [200, 290, 190, 330] product units should be pre-allocated to the four centers based on the above estimation. In general, over-allocation is often used if there is enough supply. In case all product units are sold out in a certain center, the product can be moved from a nearby center.

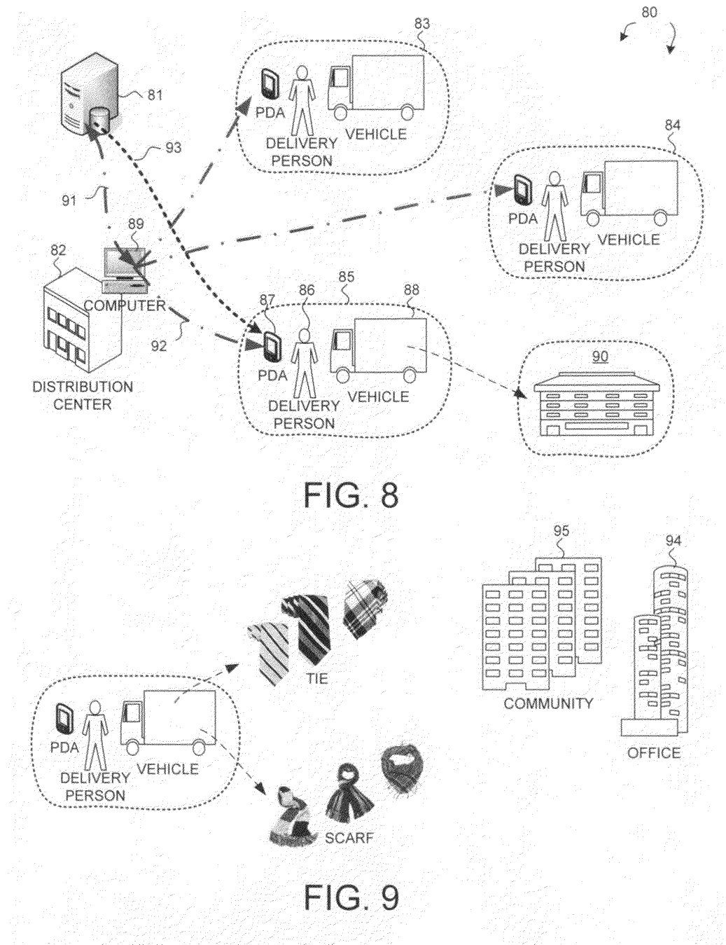

FIG. 8 illustrates a plurality of delivery entities 83-85 associated with a small distribution center 81 in a lightweight merchandise distribution system 80. As illustrated in FIG. 8, distribution center 82 is staffed by three delivery people, and each delivery person drives a delivery vehicle while carrying a wireless handheld device. In one novel aspect, the delivery person will load the delivery vehicle with a featured product before any order comes in. For example, if a product is featured by a group-buying website for one week, then delivery person 86 would load the featured product onto vehicle 88 early in the morning every day during the week and then wait for orders to come in. There are different ways for delivery person 86 to receive an order placed by a consumer located in area 90. In a first embodiment, a central server 81 processes the order and dispatches order information to a computer device 89 in distribution center 82 (e.g., depicted by a thick dash-dotted line 91). The computer device 89 further dispatches the order information to wireless handheld device 87 carried by delivery person 86 (e.g., depicted by a thick dash-dotted line 92) because delivery person 86 is located at the closest location to the final delivery address (e.g., area 90). In a second embodiment, an employee who works in distribution center 82 logs on to central server 81 to retrieve orders assigned to distribution center 82, and then sends the corresponding order information to delivery person 86. In a third embodiment, central server 81 computes which delivery person should fulfill the particular order, and then sends the corresponding order information to delivery person 86 directly (e.g., depicted by a thick dotted line 93). Once the order information is received by delivery person 86 via wireless handheld device 87, delivery person 86 drives vehicle 88 and delivers the ordered product to the consumer located in area 90.

For group-buying sites, the number of different types of products sold in a certain region at a certain time is relatively small, so there is no need to implement either a complicated warehouse management system (WMS) or a warehouse control system (WCS) for the novel lightweight distribution system. In the traditional process, the systems made order processing both cumbersome and expensive. The products for each order need to be located and moved from a huge warehouse, the products need to be packaged (e.g., wrapped or boxed by additional material in addition to the original packages from the manufacturers) and shipping labels need to be printed, etc. In the new system, order processing simply involves dispatching of the order information to the delivery person. The delivery person can receive the information through a mobile application or a short message service (SMS) on his phone. The new system does not require a complicated tracking system. A side benefit of the new system is that products do not require additional packaging so it is more environmentally friendly.

FIG. 9 illustrates a novel delivery method in a lightweight merchandise distribution system. In a traditional system, a delivery person delivers a large number of different types of packages to different addresses. In the new group-buying distribution system, a delivery person delivers a very small number of different types of products, maybe just one, to different addresses. This may result in several advantages. First, the delivery vehicle does not need to be a big truck. Instead, a small truck or minivan would be sufficient to carry the limited types of products. Second, it becomes possible for the delivery vehicle to carry samples of different variations of a product to the consumer. For example, a product often has multiple variations such as size, color, style, scent, and matching accessory etc. When a customer shops at a physical store, he/she can see, touch, and smell different selections in the store, and then make a purchase decision. For online orders, however, the customer usually has to make the choice at order time without being able to touch/smell the different selections. For group-buying, it becomes possible for the delivery person to carry all selections to the customer, and let the customer make a selection on the spot.

In the example of FIG. 9, a certain brand of tie and a certain brand of scarf are the products of the day featured by a group-buying website. The featured ties and scarves each have three selections of different colors/patterns. At the beginning of the work day, the delivery person loads the vehicle with all three selections of the tie and scarf. When a consumer places the order from the group-buying website, he/she does not need to specify the color/pattern of the tie/scarf. Instead, at the time of delivery, the consumer can look at the various selections, and even try them on, before deciding which selection to purchase.

A computer system may be used to help the delivery person further optimize the delivery sequence. For example, when there are multiple orders to be delivered, the computer system may compute and display the best sequence on the wireless handheld device so as to minimize delivery time. The delivery person may also optimize the delivery sequence using common sense. In the example of FIG. 9, if the delivery person just finished delivering a product to the 3^{rd} floor in office building 94, and he receives two new orders—one from community building 95 across the street, and the other from the 6^{th} floor of the current office building 94—he/she can choose to deliver the 6^{th} floor order first.

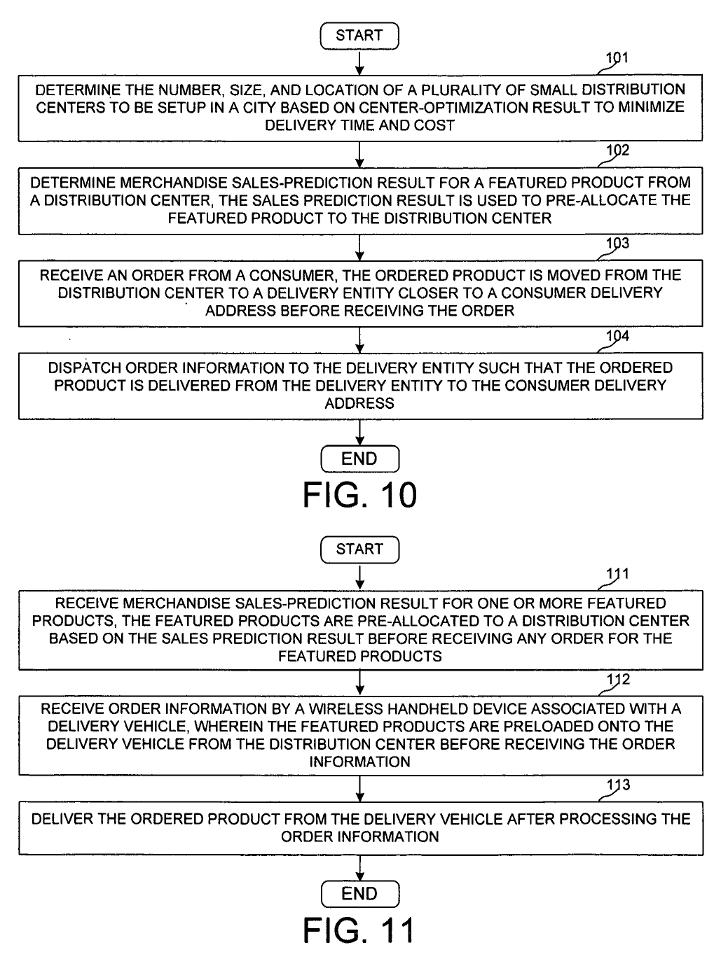

FIG. 10 is a flow chart of a method of receiving and dispatching group-buying orders in accordance with one novel aspect. A group-buying company deploys a novel lightweight merchandise distribution system to facilitate its online group-buying sales campaigns to a large population of consumers. The distribution system comprises a computer server, a plurality of small distribution centers, and a plurality of delivery entities. In step 101, the computer server determines the number, size, and location of the plurality of small distribution centers to be set up in a densely populated urban city based on center-optimization result to minimize delivery time and cost. In step 102, the computer server determines merchandise sales-prediction result based on estimated sales volume for a featured product from each distribution center. The sales-prediction result is then used to pre-allocate the featured product to each distribution center. In step 103, the computer server receives an order from a consumer. Before receiving the order, the ordered product is already moved from a distribution center to a delivery entity closer to the consumer delivery address. In step 104, the computer server dispatches order information to a wireless handheld device associated with the delivery entity such that the ordered product is delivered to the consumer delivery address.

FIG. 11 is a flow chart of a method of delivering group-buying products in accordance with one novel aspect. In the novel lightweight distribution system of FIG. 10, each distribution center covers one region within the urban city. Each distribution center is equipped with a number of delivery entities, and each delivery entity comprises a delivery person, a delivery vehicle, and a wireless handheld device. In step 111, each distribution center is pre-allocated with one or more featured products based on the estimated sales volume before receiving any order for the feature products. In step 112, a purchase order is dispatched to the wireless handheld device of the delivery entity that is closest to the delivery address. Before receiving the dispatched order information, the delivery person preloads the featured products onto the delivery vehicle. In step 113, the delivery person delivers the ordered product from the delivery vehicle to the delivery address accordingly.

In one or more exemplary embodiments, the functions described above may be implemented in hardware, software, firmware, or any combination thereof. If implemented in software, the functions may be stored on or transmitted over as one or more instructions or code on a computer-readable (processor-readable) medium. Computer-readable media include both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that both can be used to carry or store desired program code in the form of instructions or data structures, and can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies are included in the definition of medium. Disk and disc, as used herein, include compact disc (CD), laser disc, optical disc, digital versatile disc (DVD), floppy disk, and blue-ray disc where disks usually reproduce data magnetically, while discs reproduce data optically with lasers. Combinations of the above should also be included within the scope of computer-readable media.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims. In a first example, although the lightweight merchandise distribution system described above is applied in a densely populated city, it may also be applied in a town, a county, or in any geographic region that is not very densely populated. In a second example (e.g., FIG. 2), although a central computer server is illustrated in various embodiments of a lightweight merchandise distribution system, the system may include several computer servers, and different function modules (e.g., the center-optimization module and the sales-prediction module) may be running on different computer servers. In a third example (e.g., FIG. 5), although the featured products are transported from the supplier (e.g. wholesaler 59) directly to the distribution centers, it is possible to have a small warehouse in city 58 to temporarily store merchandise before they are moved to the distribution centers. The small warehouse may also be used to store unsold inventories after the sales campaign and before they are returned to the supplier.

Finally, in a fourth example, the lightweight merchandise distribution system can be applied to sales across country boundaries. For cross-border sales, custom clearance is usually required by both the country from which the merchandise originates from, and the destination country. In the new system, a sales-prediction algorithm can be used to estimate the amount of sales in each destination country, and before the sale, the featured products are shipped to each destination country. Therefore, under the new system, the custom can be cleared before the products are offered for sale, which significantly reduces the time delay from product purchasing by the consumer and the delivery.

What is claimed is:

1. A merchandise distribution system, comprising:
a merchandise sales-prediction module that determines sales-prediction result for a featured product based on estimated sales volume of the featured product from a distribution center, wherein the sales-prediction result is used to pre-allocate the featured product to the distribution center; and
an order processing module that receives an order from a consumer and dispatches order information, wherein the ordered product is moved from the distribution center to a delivery entity closer to a consumer delivery address before receiving the order information, and wherein the ordered product is delivered from the delivery entity to the consumer delivery address after receiving the order information.

2. The system of claim 1, wherein the featured product is advertised on a group-buying website to be sold at a discount price within a short duration of time.

3. The system of claim 1, wherein the merchandise sales-prediction module determines sales-prediction result based on a list of factors comprising sales volume distribution, product category, time/season factor, and demographic information associated with the distribution center.

4. The system of claim 1, further comprising:
a distribution center-optimization module that determines the number, size, and location of a plurality of small distribution centers to be set up in an urban city based on center-optimization result to minimize delivery time and cost.

5. The system of claim 4, wherein the distribution center-optimization module determines the center-optimization result based on a list of factors comprising sales address distribution, population/building coverage, traffic condition, availability of office space, and office rental of the urban city.

6. The system of claim 4, wherein the urban city has a large number of small distribution centers, and wherein each distribution center is substantially smaller than a warehouse.

7. The system of claim 1, wherein the delivery entity comprises a delivery vehicle loaded with limited number of different types of featured products, and wherein the order is processed and dispatched without tracking.

8. A computer-implemented method, comprising:
determining merchandise sales-prediction result for a featured product, wherein the sales-prediction result is based on an estimated sales volume of the featured product from a distribution center, and wherein the sales-prediction result is used to pre-allocate the featured product to the distribution center;
receiving an order from a consumer, wherein the ordered product is moved from the distribution center to a delivery entity closer to a consumer delivery address before receiving the order; and
dispatching order information such that the ordered product is delivered from the delivery entity to the consumer delivery address.

9. The method of claim 8, wherein the featured product is advertised on a group-buying website to be sold at a discount price within a short duration of time.

10. The method of claim 8, wherein the sales-prediction result of the distribution center is based on a list of factors comprising sales volume distribution, product category, time/season factor, and demographic information associated with the distribution center.

11. The method of claim 8, further comprising:
determining the number, size and location of a plurality of small distribution centers to be set up in a city based on center-optimization result to minimize delivery time and cost.

12. The method of claim 11, wherein the center-optimization result is based on a list of factors comprising sales address distribution, population/building coverage, traffic condition, availability of office space, and office rental in the city.

13. The method of claim 11, wherein the city is set up with a large number of small distribution centers, and wherein each distribution center is substantially smaller than a warehouse.

14. The method of claim 8, wherein the delivery entity comprises a delivery vehicle preloaded with a limited number of different types of featured products, and wherein the order is processed and dispatched without tracking.

15. A computer-implemented method, comprising:
receiving merchandise sales-prediction result for one or more featured products, wherein the featured products are pre-allocated to a distribution center based on the sales-prediction result before receiving any order for the featured products;
receiving order information by a wireless handheld device associated with a delivery vehicle, wherein the featured products are preloaded onto the delivery vehicle from the distribution center before receiving the order information; and
delivering one or more ordered products from the delivery vehicle after processing the order information.

16. The method of claim 15, wherein the featured products are advertised on a group-buying website to be sold at a discount price within a short duration of time.

17. The method of claim 15, wherein the delivery vehicle is loaded with limited types of the featured products, and wherein the order is processed without tracking.

18. The method of claim 15, wherein the delivery is performed without additional packaging.

19. The method of claim 15, wherein the delivery vehicle loaded with the featured products is driven to a location near where orders are likely to be received.

20. The method of claim 15, wherein different variations of the ordered products are delivered to a consumer such that the consumer selects from the different variations during the delivery time.

21. A method, comprising:
determining merchandise sales-prediction result for a featured product, wherein the sales-prediction result is based on an estimated sales volume of the featured product from a destination foreign country;
performing custom clearance and thereby shipping the featured product from an originating country to the destination foreign country based on the sales-prediction result; and
receiving an order from a consumer, wherein the ordered product is moved from the originating country to the destination foreign country before receiving the order.

22. The method of claim 21, wherein the featured products are advertised on a group-buying website to be sold at a discount price within a short duration of time.
